(19) United States
(12) Patent Application Publication
(10) Pub. No.: US 2025/0042805 A1
(43) Pub. Date: Feb. 6, 2025

(54) RECYCLED GLASS WOOL FUSION AND FIBERIZING

(71) Applicant: SAINT-GOBAIN ISOVER, COURBEVOIE (FR)

(72) Inventors: Antoine GUILLET, PARIS (FR); Marcin JANUSZ, KATOWICE (PL)

(21) Appl. No.: 18/718,263

(22) PCT Filed: Dec. 20, 2022
(86) PCT No.: PCT/FR2022/052437

§ 371 Date: Jun. 10, 2024

(30) Foreign Application Priority Data
Dec. 21, 2021 (FR) FR2114175

(51) Int. Cl. C03C 13/06; C03B 37/04; C03C 3/091; C03C 3/097

(52) U.S. Cl. CPC C03C 13/06; C03C 3/091; C03C 3/097; C03B 37/04; C03C 2213/00

(57) ABSTRACT

A composition of raw materials suitable for being melted and fiberized by external centrifugation in order to obtain a mineral wool, the composition includes between 1 and 62% by weight of glass wool.

The present invention relates to a composition of raw materials suitable for being charged into a glass furnace, melted, then fiberized by external centrifugation. It furthermore relates to methods for melting and fiberizing this composition by external centrifugation, as well as the mineral wool obtained by these methods.

It is known to “recycle” a mixture of mineral wool by making it melt in a glass furnace with a view to it to be fiberized again. Among the many advantages of such a recycling of mineral wool waste is the improvement of the energy efficiency of the glass furnace, as the collected mineral wool mixture is easier to melt than a “conventional” raw material composition comprising, among others, large quantities of silica.

In the sense of the invention, such a mineral wool mixture comprises one or more types of fibers originating from their production (factory waste), for instance from cutting and/or scrapping mats of mineral wool, or from building sites (construction site waste or demolition site waste) and/or from recycling channels allowing the recovery of such fibers from end products, whether or not they have been used. Other types of materials can be combined with mineral fibers, e.g. paper, aluminum or bituminous films, or wooden pallet parts.

Such mineral fibers may in particular consist of glass and/or rock. They are then known as glass wool and rock wool, respectively. These two types of mineral wool differ from each other by their composition, by their melting process, but also by the associated fiberizing method.

Within the meaning of the invention, a mineral wool comprises, excluding sizing:
SiO2: 30 to 75% by weight,
CaO+MgO: 5 to 40% by weight,
Al2O3: 0 to 30% by weight,
Na2O+K2O: 0 to 20% by weight,
Iron oxide: 0 to 15% by weight.

The main components of a rock wool (also referred to as “black glass” by the person skilled in the art) are, excluding sizing:
SiO2: 30 to 50% by weight,
Al2O3: 10 to 22% by weight,
CaO+MgO: 20 to 40% by weight,
Iron oxide: 0 to 15% by weight,
Na2O+K2O: 1 to 10% by weight.

In contrast, the main components of a glass wool are, excluding sizing:
SiO2: 50 to 75% by weight,
Al2O3: 0 to 8% by weight, preferentially 0.5 to 6.0%,
CaO+MgO: 5 to 20% by weight,
Iron oxide: 0 to 3% by weight,
Na2O+K2O: 12 to 20% by weight,
B2O3: 0 to 10% by weight.

The melting of rock (basalt or blast furnace slag) generally requires heating the raw materials to temperatures significantly higher than the melting of ordinary glass. Traditionally, this process is carried out in cupola furnaces, heated with large quantities of coke to temperatures of around 1500° C. Refractory furnaces, traditionally used for glass melting, cannot withstand the high temperatures required to melt rock.

Likewise, the fiberizing processes for these mineral wools depend directly on their respective composition, and are therefore not interchangeable.

Thus, the fiberizing method commonly used to produce rock fiber is the method known as external centrifugation. For this method, the material to be fiberized is poured in the molten state onto the peripheral treads of centrifuge wheels that are rotating, is accelerated by these wheels, becomes detached therefrom, and is partially transformed into fibers under the effect of centrifugal force, a gas stream being emitted tangentially to the peripheral treads of the wheels so as to pick up the fiberized material by separating it from the non-fiberized material and conveying it to a receiving member. Reference may be made, for example, to fiberizing by external centrifugation, in patent application EP195725.

Such a method of fiberizing the rock wool is to be distinguished from that commonly used for glass fiber, referred to as an internal centrifugation fiberizing method. It consists in introducing a net of the stretchable material in the molten state into a centrifuge, also called a fiberizing spinner, rotating at high speed. Such a fiberizing spinner may alternatively be equipped with a bottom and is pierced at its periphery by a very large number of orifices through which the material is sprayed in the form of filaments under the effect of centrifugal force. By means of a burner of annular shape, these filaments are then subjected to the action of a gaseous annular drawing current with a high temperature and speed (with the temperature potentially reaching 1000° C., and the speed 250 m/s, depending on the desired product) running along the wall of the centrifuge which thins them and transforms them into fibers.

There are therefore notable differences between rock wool and the glass wool, with regard to their composition, their melting process, the physical properties (resulting therefrom) from the molten material leaving the furnace (temperature, viscosity, etc.), and the associated fiberizing method. Regarding this latter aspect, it should be noted that a molten rock bath cannot technically be fiberized by internal centrifugation, nor can a bath of molten glass technically be fiberized by external centrifugation.

With regard to these technical differences, and in the context of recycling used fibers, it is therefore natural for a person skilled in the art to dedicate the recycling of rock wool to the production of rock wool exclusively, and to dedicate the recycling of glass wool to the production of glass wool exclusively, without ever considering mixing these two distinct technical fields.

The strict partitioning existing between the use of the glass wool waste on the one hand, and rock wool waste on the other hand, nevertheless has the disadvantage of complicating the associated supply channels, by increasing the number of storage locations and/or the length of transport distances.

The claimed invention is intended to provide a technical solution to the disadvantages described hereinbefore. More particularly, in at least one embodiment, the proposed technique relates to a composition of raw materials suitable for being melted and fiberized by external centrifugation in order to obtain a mineral wool, characterized in that it comprises between 1 and 62% by weight of glass wool.

For the purposes of the invention, a raw material composition is suitable for being fiberized by external centrifugation when the temperature (TLog1) of the glass bath, for a dynamic viscosity Log 1, is comprised between 1390° C. and 1490° C., and the difference (TLog1−Tlog3) between the temperatures corresponding to the viscosity values Log 1 and Log 3 is comprised between 320° C. and 390° C. As is well known in the field of glass melting, dynamic viscosity is expressed in N Log Poises, which corresponds to 10N Poises (0.1 Pa·s), each viscosity value corresponding to a given glass bath temperature.

The invention is based on the novel and inventive concept consisting in introducing glass wool into a composition of raw materials intended to be melted and then fiberized by external centrifugation, a fiberizing method usually reserved for the production of rock wool. The addition of glass fibers which, by their composition, is not initially suitable for fiberizing by external centrifugation, introduces an additional technical difficulty for a person skilled in the art in charge of melting and fiberizing. Despite these technical difficulties, such an addition of glass wool allows an operator to gain flexibility in the choice of raw materials to be used, and thus to enter opportunities that can be temporarily offered by recycling channels arranged near the melting and fiberizing facilities. It should be noted that a person skilled in the art has tools and general knowledge for, on the basis of routine tests and as detailed in the description, adapting the rest of the composition so that the latter meets the technical specifications of fiberizing by external centrifugation.

According to a particular embodiment, said composition of raw materials comprises a percentage by weight of glass wool greater than or equal to 3%, preferentially greater than or equal to 5%, preferentially greater than or equal to 10%, preferentially greater than or equal to 15%, preferentially greater than or equal to 20%, preferentially greater than or equal to 25%.

According to a particular embodiment, said composition of raw materials comprises a percentage by weight of glass wool less than or equal to 58%, preferentially less than or equal to 55%, preferentially less than or equal to 50%, preferentially less than or equal to 45%, preferentially less than or equal to 40%, preferentially less than or equal to 35%.

According to a particular embodiment, the glass wool added to said composition of raw materials is at least partially sized. Within the meaning of the invention, the term “sized glass wool” herein designates mineral wool consisting of mineral fibers having on their surface an insoluble, non-melting organic binder, which is already crosslinked.

According to a particular embodiment, the glass wool added to said composition of raw materials is at least partially virgin. Within the meaning of the invention, the expression “virgin glass wool” refers to glass wool obtained by internal centrifugation, the fibers of which are not bonded to one another by means of an organic binder, as opposed to sized glass wool. Such virgin glass wool is typically used as wool to be blown for attic insulation. The fibers of virgin wool can be coated with a thin layer of sizing or lubricant.

According to a particular embodiment, said composition of raw materials comprises at least 3% by weight of iron oxide, preferably at least 5% by weight of iron oxide.

The increase in the iron oxide content of the composition of raw materials makes it possible, after fiber drawing, to increase the maximum service temperature of the fiber obtained. In other words, such a fiber has better resistance to higher temperatures.

According to a particular embodiment, said composition of raw materials comprises at least 13% by weight of alumina, preferably at least 15% by weight of alumina.

Adding alumina (aluminum oxide) in the composition improves its biosolubility.

According to a particular embodiment, said glass wool has the following composition, in percentage by weight:
SiO2: 50 to 75%,
Al2O3: 0 to 8%, preferentially 0.5 to 6.0%,
CaO+MgO: 5 to 20%,
Iron oxide: 0 to 3%,
Na2O+K2O: 12 to 20%,
B2O3: 2 to 10%.

According to a particular embodiment, said glass wool has the following composition, in percentage by weight:
SiO2: 62.5% to 66%,
Al2O3: 1.5% to 3.1%,
CaO+MgO: 10.3 to 11.1%,
Na2O+K2O: 15.7% to 17.3%,
B2O3: 4.3% to 7.4%.

The detailed description indicates three compositions, under the names “compo no. 1”, “compo no. 2” and “compo no. 3”, which fall within this range of compositions and are commonly used in the insulation industry. Such waste can therefore be collected at numerous production sites and/or construction/demolition sites.

According to a particular embodiment, said glass wool has a boron-free composition and represents less than 48% of the total mass of said composition of raw materials.

Such a glass wool composition is known under the designation “zero-boron”, and has an application in the insulation industry.

According to a particular embodiment, said composition of raw materials comprises household cullet and/or flat glass cullet.

Adding household cullet and/or flat glass cullet makes it possible to increase flexibility in the choice of raw materials to be used. Once again, it should be noted that a person skilled in the art has general knowledge for, on the basis of routine tests, adapting the rest of the composition so that the latter meets the technical specifications of fiberizing by external centrifugation.

The invention further relates to a method comprising a step of melting such a composition of raw materials in a glass furnace.

In a known manner, such a composition of raw materials can be melted in a glass furnace with submerged and/or non-submerged burners, in an electric furnace, and/or in a hybrid furnace implementing at least one burner and electrodes. At the outlet of the furnace, the molten composition may either be immediately fiberized by external centrifugation, or be cooled and transformed into cullet, to be later (subsequently) re-melted and fiberized by external centrifugation to obtain a mineral wool.

The invention further relates to a method for manufacturing mineral wool, characterized in that it implements such a melting method and a subsequent step of fiberizing the molten composition of raw materials by external centrifugation.

The invention further relates to a mineral wool obtained according to such a manufacturing method.

As detailed in the examples of the description, such a mineral wool tends by its composition to be distinct from the wools usually made by external centrifugation, which makes it possible to distinguish it therefrom.

Further features and advantages of the invention will become apparent from the following description of particular embodiments, given merely as illustrative and non-limiting examples, and the appended FIGURES, for which:

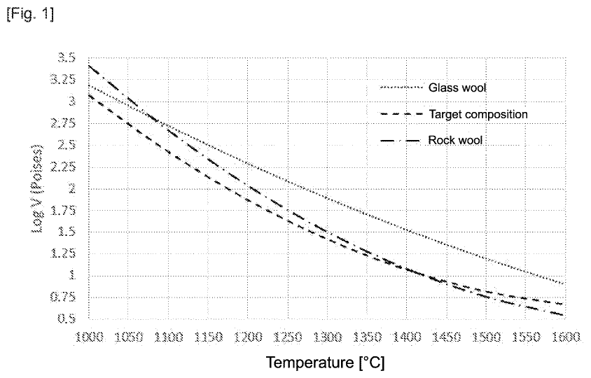

FIG. 1 is a graphic representation of the dynamic viscosity value of a composition of raw materials according to a particular embodiment of the invention, as a function of temperature variations.

Several particular embodiments of the invention are presented below. It is understood that the present invention is in no way limited by these particular embodiments, and that other embodiments are perfectly possible.

A general method that can be implemented by a furnace operator to prepare a composition according to the invention is detailed in the rest of the description.

During a first step, a target composition that satisfies the viscosity criteria for being fiberized by external centrifugation is selected. Within the meaning of the invention, such a composition is suitable for being fiberized by external centrifugation if the temperature (TLog1) of the glass bath for a dynamic viscosity Log 1 is comprised between 1390° C. and 1490° C., and if the temperature difference (TLog1−Tlog3) between the viscosities Log 1 and Log 3 is comprised between 320° C. and 390° C.

In order to assist in the selection of this target composition, a furnace operator uses models that draw a relationship between the chemical composition and the dynamic viscosity of a mixture, such as those commonly used in the glass industry.

In an industrial context and in a known manner, other considerations can also be taken into account in the selection of the target composition, such as the final cost of the composition, the energy required for the melting thereof, and compliance with certain chemical compound concentration ranges.

During a second step, the operator prepares its mixture by taking into account the respective chemical composition of each of the raw materials at its disposal, and adjusts the relative proportions of each of these raw materials to obtain the target composition.

Alternatively or in combination, these raw materials can be in the form of pure oxides, natural stones (siliceous sands, dolomite, limestone, sterile, slag, white bauxite, feldspar, anorthosite, etc.) which are already combinations of oxides, waste glass and/or rock wool, which may be derived from the production of said fibers or of worksites (construction or demolition), optional liquid or solid fuels (plastic or non-composite material, organic materials, coal), and of any type of cullet. Also included are recyclable materials containing combustible (organic) elements such as, for example, sizing mineral fibers with a binder (of the type used in thermal or acoustic insulation or those used in the reinforcement of plastics), glazings laminated with sheets of polyvinyl butyral polymers such as windshields, glass bottles (household cullet), or any type of “composite” material combining glass and plastic materials such as certain bottles. Also recyclable are “glass-metal composites or metal compounds” such as functionalized glazings with coatings containing metals.

It should be noted that, according to an alternative embodiment, an operator begins by taking into account the respective composition of each of the raw materials at its disposal for subsequently adjusting the relative proportions thereof and, empirically, determining and obtaining a target composition which, on the basis of the models at its disposal, meets the viscosity criteria for being fiberized by external centrifugation.

Once the target composition is obtained, it is charged into a glass furnace in order to be melted therein. The composition thus melted is subsequently fiberized by external centrifugation in order to form a mineral wool.

As a purely illustrative and non-limiting example, the following target composition is selected by a furnace operator:
SiO2: 45.1% by weight,
Fe2O3: 2.2% by weight,
Al2O3: 7.8% by weight,
CaO: 23.0% by weight,
MgO: 11.0% by weight,
Na2O: 8.5% by weight,
K2O: 1.5% by weight.

In order to obtain this target composition, and according to this particular embodiment, the operator has the raw materials of dolomite, steriles (“slag”) and glass wool, the respective compositions of which are detailed in Table 1 below. The proportions by weight (% w) of each of these raw materials are adjusted, as mentioned in Table 1 [Tables 1], for obtaining the target composition. [Table 1]

TABLE 1
Compositions and mass concentrations of raw
materials for obtaining a target composition

| | % w | SiO2 | Fe2O3 | Al2O3 | CaO | MgO | Na2O | K2O |
|---|---|---|---|---|---|---|---|---|
| Dolomite | 17% | 5.5 | 1.2 | 1.8 | 33 | 15 | 0.1 | 0.4 |
| Slag | 23% | 38.8 | 0.1 | 9.2 | 41.8 | 7 | 0.4 | 0.6 |
| Glass | 60% | 53 | 3 | 8 | 10 | 10 | 12 | 2 |
| wool | | | | | | | | |
| Target | | 45.1 | 2.2 | 7.8 | 23.0 | 11.0 | 8.5 | 1.5 |
| compo- | | | | | | | | |
| sition | | | | | | | | |

Based on a model commonly used by the glass industry, the operator determines the dynamic viscosity value of the target composition, depending on the variation in its temperature. It should be noted that this target composition comprises 60% by weight of glass wool.

As a comparison, the dynamic viscosity values are also calculated, depending on the temperature variations:
glass wool, the composition of which is given in Table 1,
a standard rock wool, whose composition by weight is SiO2: 37% w; Fe2O3: 5% w; Al2O3: 21% w; CaO: 20% w; MgO: 14% w; Na2O: 2% w; K2O: 1% w.

The set of dynamic viscosity values (in Log V) obtained for each of these three compositions is detailed in Table 2 [Tables 2] below, and shown graphically in FIG. 1.

TABLE 2
Dynamic viscosity values (in Log V) depending on the chemical
composition of the mixture and of its temperature (in ° C.)

| | | | Target |
|---|---|---|---|
| Temperature | Glass wool | Rock wool | composition |
| 1000° C. | 3.184 | 3.411 | 3.069 |
| 1100° C. | 2.719 | 2.671 | 2.419 |
| 1200° C. | 2.288 | 2.036 | 1.869 |
| 1300° C. | 1.891 | 1.506 | 1.419 |
| 1400° C. | 1.528 | 1.081 | 1.069 |
| 1500° C. | 1.199 | 0.761 | 0.819 |
| 1600° C. | 0.904 | 0.546 | 0.669 |

Table 3 [Tables 3] below gives us information on the temperature values TLog 1 and TLog 3 (in ° C.) respectively corresponding to dynamic viscosity values of Log 1 and Log 3 obtained for these same compositions.

TABLE 3
Temperature values (in ° C.) as a function of the chemical
composition of the mixture and of its dynamic viscosity (in Log V)

| | | | Target |
|---|---|---|---|
| | Glass wool | Rock wool | composition |
| Tlog 1 | 1563° C. | 1417° C. | 1390° C. |
| Tlog 3 | 1036° C. | 1062° C. | 1000° C. |
| Tlog1 − Tlog3 | 528° C. | 355° C. | 390° C. |

Unlike the glass wool composition, the target composition and the rock wool composition both have a temperature TLog1 comprised between 1390° C. and 1490° C., as well as a temperature difference (TLog1−TLog3) comprised between 320° C. and 390° C. These two compositions therefore satisfy the dynamic viscosity criteria for being fiberized by external centrifugation.

According to other particular embodiments of the invention, the glass wool waste available to the operator has 3 (three) distinct chemical compositions which are detailed in Table 4 [Tables 4] below, and whose references are compo no. 1, compo no. 2 and compo. 3:

TABLE 4
Chemical compositions of three glass wools

| | SiO2 | Al2O3 | CaO | MgO | Na2O | K2O | B2O3 | P2O5 |
|---|---|---|---|---|---|---|---|---|
| Compo | 65.3 | 2.1 | 8.1 | 2.4 | 16.4 | 0.7 | 4.5 | |
| no. 1 | | | | | | | | |
| Compo | 65.5 | 1.7 | 7.5 | 3.0 | 16.4 | 0.7 | 4.9 | 0.12 |
| no. 2 | | | | | | | | |
| Compo | 63.0 | 2.9 | 7.4 | 3.5 | 15.2 | 0.7 | 7.2 | |
| no. 3 | | | | | | | | |

Starting from each of these glass wool compositions, by adding pure oxides thereto, and taking into account the combinations of limiting oxides, the inventors were able to obtain target compositions which have a maximum mass concentration of glass fibers, while satisfying the viscosity criteria necessary for fiberizing by external centrifugation.

All of these data are detailed in Table 5 [Tables 5] below:

TABLE 5
Maximum concentration, by weight, of glass
wool in 3 target compositions, corresponding
dynamic viscosity and temperatures

| | Compo | Compo | Compo |
|---|---|---|---|
| Glass wool reference | no. 1 | no. 2 | no. 3 |
| Maximum concentration of | 57% | 57% | 61% |
| glass wool by weight | | | |

Target composition (in percentage by weight % w)

| | | | |
|---|---|---|---|
| SiO2 | 48.3 | 48.3 | 46.3 |
| Al2O3 | 3.1 | 2.8 | 3.5 |
| CaO | 35.2 | 34.9 | 34.4 |
| MgO | 1.4 | 1.7 | 2.1 |
| Na2O | 9.1 | 9.0 | 8.8 |
| K2O | 0.4 | 0.4 | 0.4 |
| B2O3 | 2.6 | 2.8 | 4.4 |
| P2O5 | | 0.1 | |

Dynamic viscosity vs. Temperature

| | | | |
|---|---|---|---|
| TLog 1 | 1390° C. | 1390° C. | 1390° C. |
| TLog 3 | 1000° C. | 1000° C. | 1000° C. |
| TLog1 − TLog3 | 390° C. | 390° C. | 390° C. |

The analysis of the results obtained makes it possible to conclude that each of the three target compositions detailed in Table 5 has a temperature TLog1 comprised between 1390° C. and 1490° C., as well as a temperature difference (TLog1−TLog3) comprised between 320° C. and 390° C. These three target compositions therefore satisfy the dynamic viscosity criterion for being fiberized by external centrifugation.

1. A composition of raw materials suitable for being melted and fiberized by external centrifugation in order to obtain a mineral wool, the composition comprising between 1 and 62% by weight of glass wool.

2. The composition of raw materials according to claim 1, comprising at least 3% by weight of iron oxide.

3. The composition of raw materials according to claim 1, comprising at least 13% by weight of alumina.

4. The composition of raw materials according to claim 1, wherein the glass wool has the following composition, in percentage by weight:
SiO2: 50 to 75%,
Al2O3: 0 to 8%,
CaO+MgO: 5 to 20%,
Iron oxide: 0 to 3%,
Na2O+K2O: 12 to 20%,
B2O3: 2 to 10%.

5. The composition of raw materials according claim 4, wherein the glass wool has the following composition, in percentage by weight:
SiO2: 62.5% to 66%,
Al2O3: 1.5% to 3.1%,
CaO+MgO: 10.3 to 11.1%,
Na2O+K2O: 15.7% to 17.3%,
B2O3: 4.3% to 7.4%.

6. The composition of raw materials according to claim 1, wherein said glass wool has a boron-free composition and represents less than 48% of a total mass of said composition of raw materials.

7. The composition of raw materials according to claim 1, further comprising household cullet and/or flat glass cullet.

8. A method comprising a step of melting, in a glass furnace, a composition of raw materials according to claim 1.

9. A method for manufacturing mineral wool, comprising performing the melting method according to claim 8, and a subsequent step of fiberizing by external centrifugation of the molten composition of raw materials.

10. A mineral wool obtained according to a manufacturing method according to claim 9.

11. The composition of raw materials according to claim 2, comprising at least 5% by weight of iron oxide.

12. The composition of raw materials according to claim 3, comprising at least 15% by weight of alumina.

13. The composition of raw materials according to claim 4, wherein the glass wool comprises, in percentage by weight, Al2O3: 0.5 to 6.0%.
